(19) United States
(12) Patent Application Publication
(10) Pub. No.: US 2013/0104712 A1
(43) Pub. Date: May 2, 2013

(54) Apparatus and Method for Cutting a Cathode Ray Tube

(71) Applicant: CRT Heaven Ltd, Highbridge (GB)

(72) Inventors: David J. Harris, Wellington (GB); Neil R. Seacroft, Somerset (GB)

(73) Assignee: CRT Heaven Ltd, Highbridge (GB)

(21) Appl. No.: 13/722,053

(22) Filed: Dec. 20, 2012

Related U.S. Application Data
(63) Continuation of application No. 11/816,975, filed on Jun. 2, 2008, now abandoned.

(30) Foreign Application Priority Data
Jun. 3, 2005 (GB) 0511401.2

(51) Int. Cl. B26D 5/20; B26D 7/18; B26D 7/01

(52) U.S. Cl. CPC B26D 5/20; B26D 7/01; B26D 7/1863
USPC 83/36; 83/367; 83/100

(57) ABSTRACT

An apparatus for cutting a cathode ray tube comprises a support means for supporting the screen of the cathode ray tube, first and second sensors for determining the external dimensions of the screen, first and second spaced diamond cutting means, and displacement means for moving the support means relative to the diamond cutting means.

The present invention relates to an apparatus and method for cutting a cathode ray tube, and in particular, to cutting a cathode ray tube (CRT) into two parts for the purpose of recycling of its component parts.

### BACKGROUND OF THE INVENTION

CRTs are used, inter alia, in televisions, computer monitors and monitors for specialist applications, for example, in cash dispensers and industrial applications. In the UK alone, it is estimated that around 100,000 tonnes of CRTs are scrapped every year and require disposal. A CRT has a funnel section and a neck section, which are typically made from glass containing high levels of lead oxide. The funnel section is attached to a screen, which is typically made from glass containing high levels of barium oxide. The screen and funnel section are connected at a circumferential joint, known as a frit joint, which contains high levels of lead.

Furthermore, the inside surface of the screen is coated with a fluorescent powder comprising a mixture of phosphors. The coating may also contain cadmium and other heavy metals. When a screen is separated from a funnel section for recycling, as disclosed in WO 03/081626 A1, in the name of Holappa and Leskinen, the coating must be removed before the glass in the screen can be recycled. This is usually achieved by the coating being brushed by hand by an operator, and the dust removed by a vacuum hose. This exposes the operator to an environment in which there are airborne phosphors and heavy metals, which are dangerous to health.

It is widely appreciated that CRTs should be disposed of in a controlled environment, which minimises the risk to health. There is therefore a need to provide an apparatus and method which is capable of separating the funnel and screen of a CRT in a controlled environment, and which is capable of removing the coating on the inside of the screen.

### SUMMARY OF THE INVENTION

According to the present invention there is provided an apparatus for cutting a cathode ray tube having a funnel and screen comprising a support means for supporting the screen, first and second sensors for determining the external dimensions of the screen, first and second diamond cutting means spaced a variable distance apart, and displacement means for moving the support means relative to the diamond cutting means.

Preferably the displacement means is adapted to move the support means between the first and second diamond cutting means.

Preferably the displacement means is adapted to move the support means relative to the diamond cutting means at a variable speed.

The displacement means is preferably a table mounted on parallel rails.

Preferably the displacement means is driven by a variable speed electric or hydraulic motor through a rack and pinion.

Preferably the vertical position of the support means relative to the first and second cutting means is adjustable.

Preferably the angular position of the support means is adjustable about a vertical axis.

Preferably the spacing of the diamond cutting means is set in response to a reading of the external dimensions of the screen determined by the first and second sensors.

Preferably the first and second diamond cutting means are each mounted on a slider, the axis of movement of which is perpendicular to an axis of displacement of the support means.

Preferably the first and second sensors are optical or ultrasonic.

Preferably the diamond cutting means each comprise cutting wheels with a diamond coated periphery.

Preferably a second support means is provided for the funnel of the cathode ray tube.

Preferably a brush or brushes are disposed for orbital movement in a plane perpendicular to a vertical axis of the support means.

Preferably air extraction is provided for the brush or brushes.

Preferably air extraction is provided for each of the first and second diamond cutting means.

Preferably the apparatus is disposed in a cabinet, air flow from which is continuously extracted and filtered to remove airborne particles.

According to a second aspect of the present invention there is provided a method of cutting a cathode ray tube having a funnel and screen comprising the steps of, supporting the screen of the cathode ray tube from below using support means, determining the external dimensions of the screen using first and second sensors, passing the cathode ray tube between spaced first and second diamond cutting means in a first direction to cut through opposed sides of the cathode ray tube, rotating the cathode ray tube through an angle of 90 degrees, and passing the cathode ray tube back between the spaced first and second diamond cutting means in the other direction to cut through the other opposed sides of the cathode ray tube, thereby separating the screen from the funnel.

Preferably the speed of movement of the cathode ray tube through the sensors and cutting means is varied for the purpose of optimising the utilisation of the apparatus.

Preferably the first and second diamond cutting means are spaced in response to the reading of the external dimensions of the screen determined by the first and second sensors.

Preferably the spacing between the first and second diamond cutting means is reset between the first and second passes of the cathode ray tube between the cutting means.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 shows a schematic side view of an apparatus for cutting a cathode ray tube in accordance with the invention;

FIG. 2 shows an alternative schematic side view of the apparatus of FIG. 1, with a displacement and support means shown in cross section in first and second positions;

FIG. 3 shows a schematic plan view from above of a cathode ray tube being passed though a pair of diamond cutting wheels on a first pass;

FIG. 4 shows a schematic plan view from above of the cathode ray tube being passed though the pair of diamond cutting wheels on a second pass;

FIG. 5 shows a schematic side view of a power brushing assembly; and

FIG. 6 shows a schematic cross-sectional view of the brushing assembly of FIG. 5 in use.

### DETAILED DESCRIPTION OF ILLUSTRATED EMBODIMENT

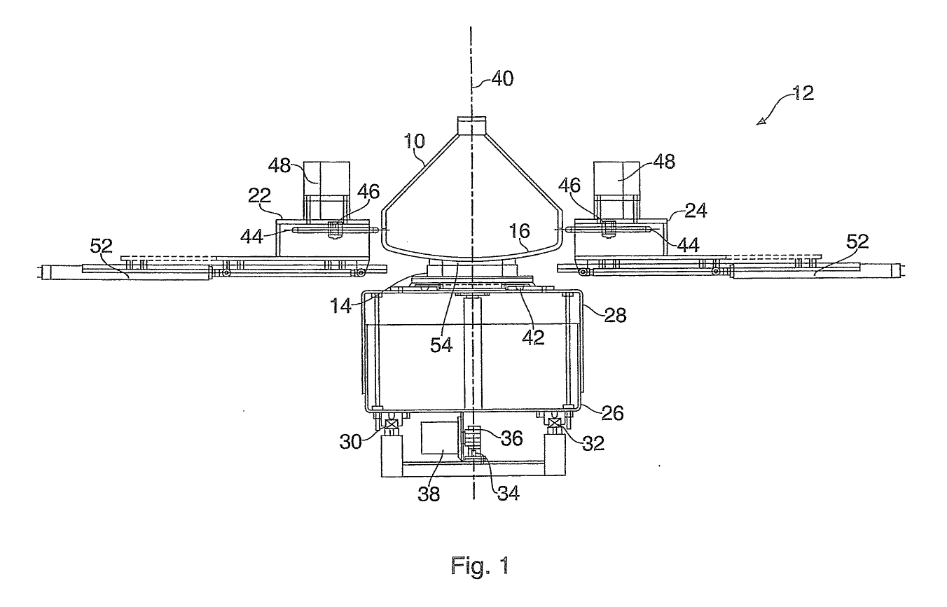

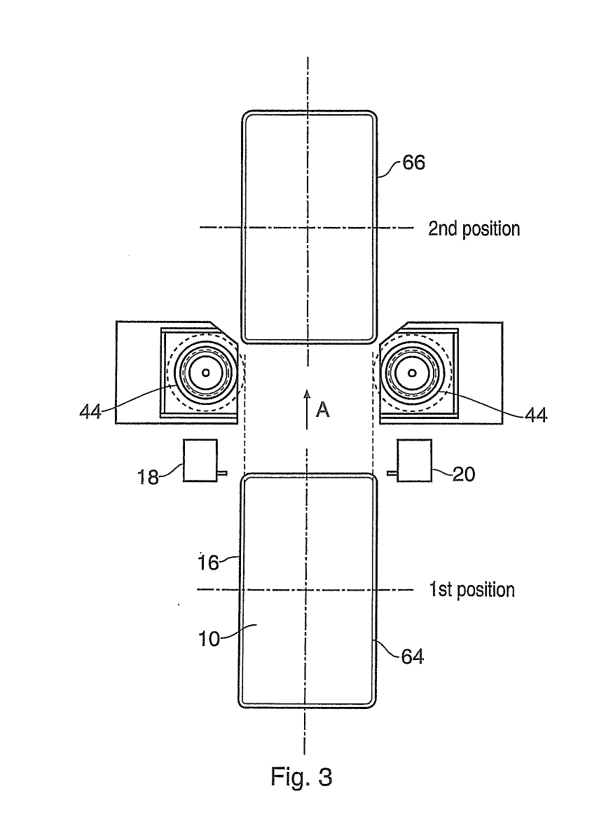

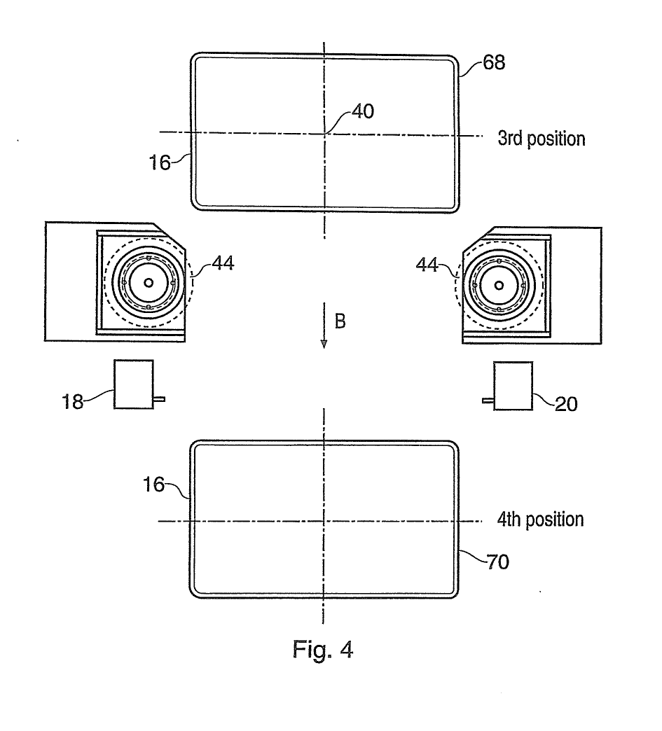

Referring firstly to FIG. 1, an apparatus for cutting a cathode ray tube 10 is indicated generally at 12. The apparatus 12 comprises a support means 14 for supporting the screen 16 of the cathode ray tube 10, first and second sensors 18,20 (shown in FIGS. 3 and 4) for determining the external dimensions of the screen 16, first and second spaced diamond cutting means 22,24, and displacement means 26 for moving the support means 14 relative to the diamond cutting means 22,24.

The displacement means 26 comprises a movable table 28 mounted on spaced parallel rails 30, 32. The table 28 is powered along the rails 30, 32 by means of a rack and pinion 34, 36. The rack 34 is rigidly fixed beneath the table 28, in alignment with and between the rails 30, 32. A motor 38 is slung beneath the table 28, which drives the pinion 36. The motor 38 is a variable speed hydraulic or electric motor.

The support means 14 and upper surface of the table 28 are vertically adjustable relative to the height of the rails 30, 32 and the diamond cutting means 22, 24. This is to enable accurate cutting of the cathode ray tube 10 below the frit joint, because the frit joint include a high proportion of lead, as does the funnel portion of the CRT 10. The vertical adjustment of the table 28 can be powered hydraulically or electrically.

The angular position of the support means 14 is also adjustable about a vertical axis 40, which is perpendicular to the plane of the table 28. A slew ring is provided in the support means 14 which enables rotation of the support means 14 about the axis 40. The slew ring 42 should be sufficiently strong to support the load of a CRT 10 having a 107 cm (42 inch) screen. The slew ring 42 can be powered by means of an electric or hydraulic motor.

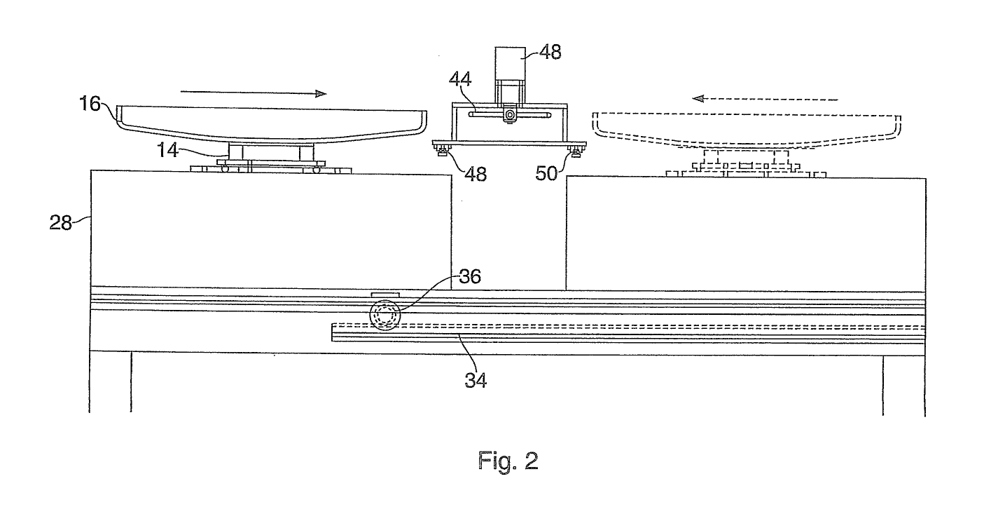

Each diamond cutting means 22, 24 includes a diamond cutting wheel 44, which comprises a metal wheel with a diamond coated periphery. Each diamond cutting wheel is mounted on the drive shaft 46 of a hydraulic or electric motor 48. Each cutting means 22, 24 is slidably mounted on rails 48, 50 (shown in FIG. 2) and is urged backwards and forwards along the rails by means of a hydraulic cylinder 52. As will be explained in more detail below, the position of the cutting means 22, 24 is set in response to a reading of the external dimensions of the screen 16 of the CRT 10 by the first and second sensors 18, 20.

The CRT 10 is held in position on the support means 14 by means of a vacuum pad 54 which acts on the viewing surface of the screen 16.

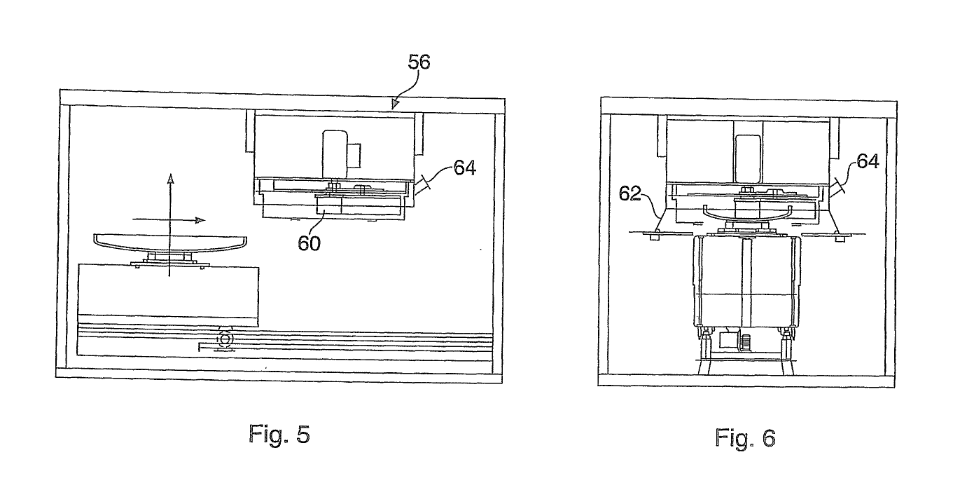

Referring now to FIG. 5, the apparatus 12 also includes a brush assembly, indicated at 56, which is used to remove the phosphor coating from the inside of a screen 16, once separated from the rest of the CRT 10. The brush assembly 56 comprises an hydraulic or electric motor 58 which powers one or more brushes 60 to move in an orbital action. The brush assembly 56 is contained within a cabinet 62, shown more clearly in FIG. 6, and a dust extraction unit is connected to the cabinet by means of a hose 64 at the area of brushing. The brush assembly 56 is disposed vertically above a position of the movable table 28, or above a second movable table of similar design, further along a recycling process plant.

In operation, a CRT 10 is positioned with its screen 16 supported face down on the vacuum pad 54. As shown in FIG. 3, the CRT 10 is in a first position, indicated at 64, at this point in time. The CRT 10 is then moved between the sensors 18, 20 on the table 28 in the direction of arrow A. The sensors determine the width of the screen 16, from which the first and second cutting wheels are moved by the first and second cutting means 22, 24 to an optimum position for cutting through the glass of the screen along opposed sides. The screen is then advanced through the cutting wheels in the direction of arrow A to a second position, indicated at 66. As the screen passes the sensors 18, 20, the sensors detect the length of the screen 16, ie the length of the sides of the screen that is cut, and the CRT 10 is rotated through 90° about the vertical axis 40 to a third position indicated at 68 in FIG. 4.

The cutting means 22, 24 are then moved to a position such that the diamond cutting wheels 44 can optimally cut through the glass of the other opposed sides of the screen, and the table and screen is moved back through the diamond cutting wheels 44 in the direction of arrow B. The funnel of the CRT 10 is thus separated from the screen 16 and is supported and removed from above. Finally, the screen moves to the fourth position indicated at 70 in FIG. 4. The speed of movement of the table past the first and second cutting means 22, 24 is varied to optimise the utilisation of the apparatus. In other words, the table is advanced at high speed from the rest positions to the point of cutting, the table is then slowed to the optimum cutting speed, and when cutting is completed the table is accelerated to the next rest position.

After separation of the screen, the table 28 is advanced to a position underneath the brush assembly 56. Alternatively, the screen 16 is transferred to a further table and support apparatus 14, which is then subsequently moved to the brush assembly 56. The height of the table above the rails 30, 32 is then increased, until the inside of the screen contacts the brushes 60. Operation of the brushes then causes the brushes to remove the phosphor coating from the inside of the screen 16. The brushes remove sufficient of the phosphor coating to enable the screen to be handled in an uncontrolled environment prior to be recycled. In the recycling process, the screen is also chemically cleaned.

In a further embodiment, not shown, the brush assembly comprises a pair of roller brushes, which are disposed with axes in substantially the same plane, which may be horizontal. The axes of the rollers are not parallel with one another, but have an angle between them, and the rollers are driven to counter-rotate. This facilitates the removal of the phosphor coating, particularly in the corners of the screen 16. This arrangement is preferred for removing the coating from large screens, for example, 106 cm (42 inch).

Both the cutting and brushing is controlled by means of a computer control system, and as cutting and brushing is taking place, air flow from respective cabinets is continuously extracted and filtered to remove airborne particles. Cabinets are provided around all parts of the apparatus, which are maintained at a slightly negative pressure by means of air extraction, in order to ensure that airborne particles from the cutting and brushing processes are not freely released to the surrounding atmosphere.

The apparatus 12 and its method of operation enable cathode ray tubes of different sizes to be cut up prior to recycling, both at high speed and without risk to human health.

1.-20. (canceled)

21. An apparatus for cutting a cathode ray tube having a funnel and a screen, the apparatus comprising:
a support means that supports a cathode ray tube with the screen contacting the support means,
first and second sensors that determine the external dimensions of the screen,
first and second diamond cutting means,
means for varying the spacing between the first and second diamond cutting means based on the external dimensions of the screen determined by the first and second sensors,
displacement means configured to move the support means along an axis of displacement relative to the diamond cutting means, and
rotation means configured to adjust the angular position of the support means,
the apparatus being configured to operate by displacing a cathode ray tube in a first direction along the axis of displacement between the cutting means to perform a first cut, by rotating the support member through 90°, and by displacing the cathode ray tube in a second direction opposite to the first direction along the axis of displacement between the cutting means to perform a second cut.

22. An apparatus as claimed in claim 21, in which the displacement means is configured to move the support means relative to the diamond cutting means at a variable speed.

23. An apparatus as claimed in claim 21, in which the displacement means is a table mounted on parallel rails.

24. An apparatus as claimed in claim 23, further comprising a variable speed electric or hydraulic motor which is coupled to the displacement means by a rack and pinion mechanism.

25. An apparatus as claimed in claim 21, in which the vertical position of the support means relative to the first and second cutting means is adjustable.

26. An apparatus as claimed in claim 21, in which the first and second diamond cutting means are each mounted on a slider, having an axis of movement which is perpendicular to the axis of displacement of the support means.

27. An apparatus as claimed in claim 21, in which the first and second sensors are optical or ultrasonic.

28. An apparatus as claimed in claim 21, in which the diamond cutting means each comprise a cutting wheel with a diamond-coated periphery.

29. An apparatus as claimed in claim 21, in which a second support means is provided, which is configured to support the funnel of the cathode ray tube.

30. An apparatus as claimed in claim 21, in which a brush or brushes are disposed for orbital movement in a plane perpendicular to a vertical axis of the support means.

31. An apparatus as claimed in claim 30, in which air extraction is provided for the brush or brushes.

32. An apparatus as claimed in claim 21, in which air extraction is provided for each of the first and second diamond cutting means.

33. An apparatus as claimed in claim 21, the apparatus being disposed in a cabinet, air flow from which is continuously extracted and filtered to remove airborne particles.

34. A method of cutting a cathode ray tube having a funnel and screen comprising the steps of:
supporting the screen of the cathode ray tube from below using support means;
determining a first dimension of the screen using first and second sensors;
spacing first and second diamond cutting means a first distance apart based on the first dimension of the screen;
first passing the cathode ray tube between the spaced first and second diamond cutting means in a first direction to cut through opposed sides of the cathode ray tube;
determining a second dimension of the screen using the first and second sensors;
rotating the cathode ray tube through an angle of 90 degrees;
spacing the first and second diamond cutting means a second distance apart based on the second dimension of the screen; and
second passing the cathode ray tube back between the spaced first and second diamond cutting means in a second direction opposite to the first direction to cut through the other opposed sides of the cathode ray tube, thereby separating the screen from the funnel.

35. A method as claimed in claim 34, in which the speed of movement of the cathode ray tube through the sensors and cutting means is varied for the purpose of optimizing the utilization of the apparatus.

36. A method as claimed in claim 34, in which the second dimension is determined during the first passing.

37. A method as claimed in claim 34, in which the spacing between the first and second diamond cutting means is reset between the first and second passes of the cathode ray tube between the cutting means.
